(19) United States
(12) Patent Application Publication
(10) Pub. No.: US 2010/0057483 A1
(43) Pub. Date: Mar. 4, 2010

(54) Software tool for developing patent submissions

(76) Inventor: Michael L. Peterson, El Dorado, KS (US)

Correspondence Address: CHRISTOPHER P MAIORANA, PC;LSI Corporation, 24840 HARPER, SUITE 100, ST CLAIR SHORES, MI, 48080, US

(21) Appl. No.: 12/201,036

(22) Filed: Aug. 29, 2008

(51) Int. Cl. G06Q 99/00; G06F 17/30; G06F 7/20

(52) U.S. Cl. 705/1; 707/104.1; 707/5; 707/E17.008; 707/E17.014

(57) ABSTRACT

A computer readable medium configured to store instructions for executing the following steps (A) accepting a first number of user parameters to be organized as a patent idea, (B) accepting a second number of user parameters to add to the patent idea, and (C) automatically converting the patent idea into a patent disclosure. The patent disclosure may comply with a number of criteria specific to a particular organization.

### FIELD OF THE INVENTION

The present invention relates to document management generally and, more particularly, to a method and/or apparatus for implementing a software tool for developing patent disclosure submissions.

### BACKGROUND OF THE INVENTION

When developing new invention disclosures, an inventor edits a word processing document template that just has headings for the various sections of information needed. The details are filled in on a disclosure-by-disclosure basis. Sometimes after submitting a few dozen disclosures, perhaps over the course of several years, an inventor can start to lose track of what has been submitted. Such a case runs the risk of working on an idea that has already been through the review process. Also, to get information about each piece of information needed, as well as information about what the disclosure process actually is at a particular company (which is useful to know when you are new to a company, or the process changes), separate documents need to be accessed.

It would be desirable to implement a document management system specific to developing patent submissions.

### SUMMARY OF THE INVENTION

The present invention concerns a computer readable medium configured to store instructions for executing the following steps (A) accepting a first number of user parameters to be organized as a patent idea, (B) accepting a second number of user parameters to add to the patent idea, and (C) automatically converting the patent idea into a patent disclosure. The patent disclosure may comply with a number of criteria specific to a particular organization.

The objects, features and advantages of the present invention include (i) providing a software tool for developing patent submissions (ii) streamlining the submission process, (iii) storing historical records of submissions, (iv) providing guided entering of information for an invention disclosure, (v) providing a search feature for previous submissions, (vi) providing a web page where most functions may be carried out, and/or (vii) providing an auto-submit option for the invention disclosures.

### BRIEF DESCRIPTION OF THE DRAWINGS

These and other objects, features and advantages of the present invention will be apparent from the following detailed description and the appended claims and drawings in which:

FIG. 1 is a flow diagram of an embodiment of the present invention;

FIG. 2 is another flow diagram of another embodiment of the present invention;

FIG. 3 is a block diagram of an example configuration of the present invention;

FIG. 4 is a state diagram of another embodiment of the present invention; and

FIG. 5 is a block diagram of a sample screen shot.

### DETAILED DESCRIPTION OF THE PREFERRED EMBODIMENTS

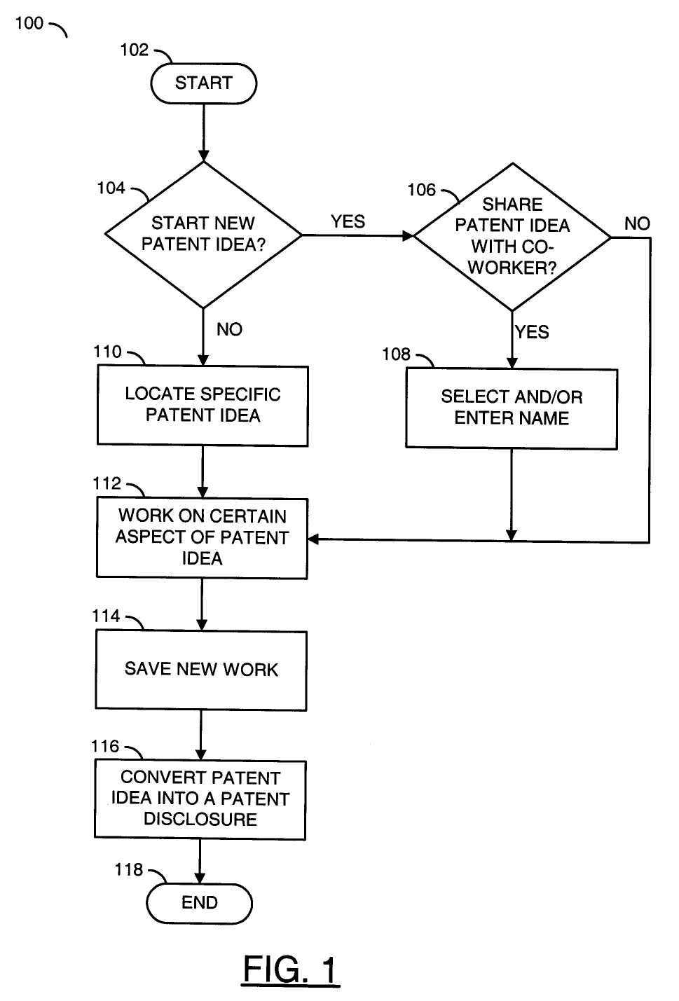

Referring to FIG. 1, a flow diagram of a method (or process) 100 is shown in accordance with an embodiment of the present invention. The process 100 generally comprises a step (or state) 102, a decision step (or state) 104, a decision step (or state) 106, a step (or state) 108, a step (or state) 110, a step (or state) 112, a step (or state) 114, a step (or state) 116, and a step (or state) 118.

The step 102 normally starts the process 100. In the decision step 104, the process determines whether to start a new disclosure or idea (e.g., a patent idea). The decision step 104 may respond to an input received from an inventor (e.g., the inventor may enter a first number of user parameters). If a new patent idea is started, then the process 100 may move to the decision step 106. If a new patent idea is not started, then the process 100 may move to the step 110. In the step 110, an inventor may locate a specific patent or idea to work on. In one example, a list of existing patent ideas may be displayed. In the decision step 106, the inventor may decide whether to share the patent idea with someone else (e.g., a co-worker). If the patent idea is shared, the process 100 may move to the step 108. If patent is not shared, then the process 100 may move to the step 112.

In the step 108, the inventor may select and/or enter the name of one or more co-workers that may share the patent idea. In the step 112, the inventor may work on a certain aspect of the patent idea (e.g., the inventor may enter a second number of user parameters). In the step 114 the inventor may save the new work. The step 116 may convert the patent idea into a patent disclosure. The patent disclosure may be formatted to comply with a format specific to a particular company and/or organization. In the step 118, the process 100 may end.

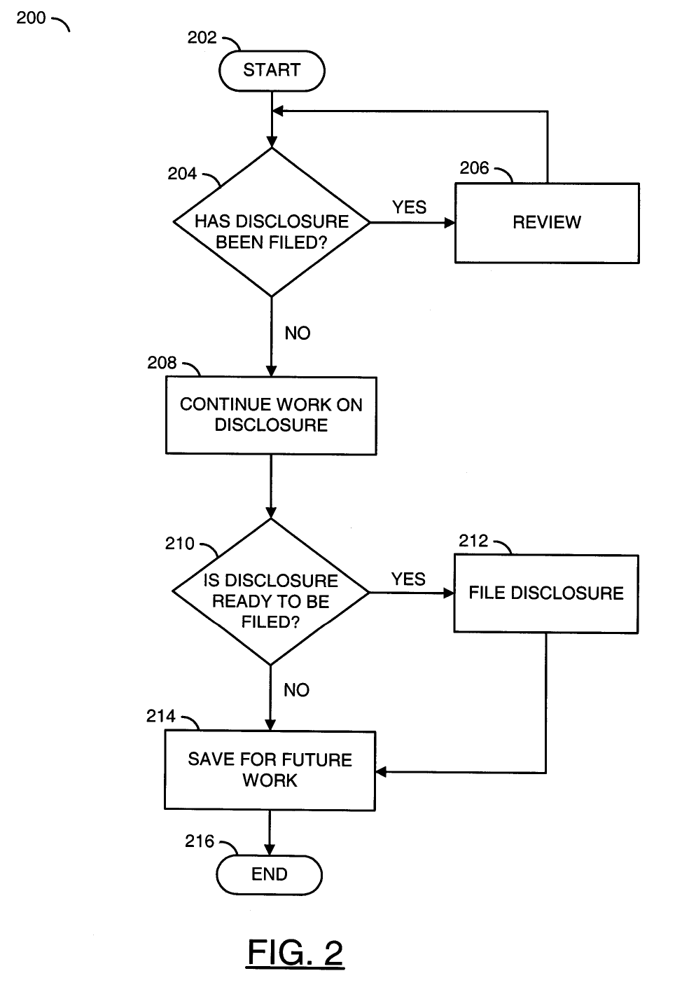

Referring to FIG. 2, a flow diagram of a method (or process) 200 is shown in accordance with another embodiment of the present invention. The process 200 generally comprises a step (or state) 202, a decision step (or state) 204, a step (or state) 206, a step (or state) 208, a decision step (or state) 210, a step (or state) 212, a step (or state) 214, and a step (or state) 216.

The step 202 may start the process 200. The process 200 may allow modifications after the submission of FIG. 1. The decision step 204 may determine if a disclosure has been filed. If a disclosure has been filed, then the process 200 may move to the step 206. In the step 206, the inventor may review the filed disclosure. If a disclosure has not been filed, then the process 200 moves to the step 208. In the step 208, the inventor may continue to work on the disclosure. In the decision step 210 the inventor may determine if the disclosure is ready to be filed. If the disclosure is ready to be filed, the process 200 may move to the step 212. In the step 212, the inventor may present the disclosure for filing. Once a disclosure is ready for filing, the disclosure may be forwarded to an appropriate patent attorney registered in the jurisdiction filing is desired (e.g., United States, Japan, etc.). The patent attorney may review and/or modify the disclosure as needed prior to filing. If the disclosure is not ready for filing, then the process 200 may move to the step 214. In the step 214, the inventor may save the disclosure for future use and/or filing. The step 216 may end the process 200.

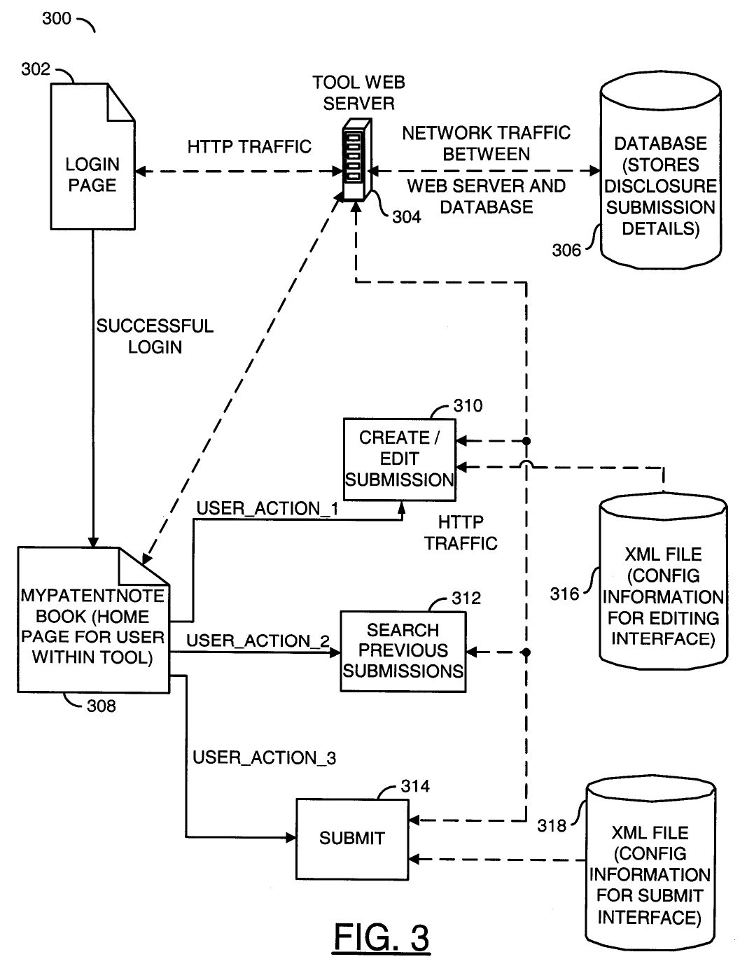

Referring to FIG. 3, a system 300 is shown. The system 300 may be considered a tool. In one example, the system 300 may be considered a software tool. The system 300 generally comprises a block 302, a block 304, and a block 306. The block 302 may be implemented as a login page. The block 304 may be implemented as a server. In one example, the server 304 may be implemented as a web server. In another example, the block 304 may be implemented as a local server. The block 306 may be implemented as a database. The system 300 may also include a block 308, a block 310, a block 312, a block 314, a block 316 and a block 318. The block 308 may be implemented as a home page. The block 308 may be considered a writing module. The block 310 may be implemented as a submission block. The block 312 may be implemented as a search block. The block 314 may be implemented as a submit block. The block 316 may store one or more files (e.g., one or more XML files). The block 318 may store one or more files (e.g., one or more XML files).

An embodiment of the invention may be implemented as a patent writer tool. In one example, the tool 300 may be implemented in software. The software tool 300 may help an inventor perform one or more actions, including but not limited to (i) filling out necessary information needed for a process of a particular company for submitting disclosures, (ii) providing links to the process for a particular company, and then have the links hot-linked to various input sections (so the inventor may see the relevant part of the process when they are entering the data for that part), (iii) automatically handle submitting the patent to the attorneys that represent the company (where applicable) and/or (iv) allow collaboration between different inventors on one or more patents.

In one embodiment, the software tool 300 may be implemented as a web-based tool, utilizing a database-backend. The inventor may log into the system. Upon logging in, the inventor may be greeted with a home page (e.g., a “MyPatentNotebook” page). However, other home pages may be implemented to meet the design criteria of a particular implementation. The inventor may have options to work on an existing patent idea, create a new patent idea, discuss an idea with a fellow employee, etc. In one example, an inventor authentication may be handled by a third-party tool (e.g., LDAP or other appropriate tool). Furthermore, information gathered for the submission by an inventor may be stored in a relational database.

Another embodiment of the software tool 300 may provide the patent writer module 310. The patent writer module 310 may help an inventor compose information useful for drafting a patent application. The module 310 may present the inventor with one or more entry boxes that may be filled with the information used in a submission. Each box may have a help link that may be clicked. The help link may take the inventor to the relevant part of the process. The inventor may fill out part of the information by presenting a request (e.g., USER_ACTION_1). The patent idea may then be saved to be worked on later. The home page 308 may show which patent ideas still need work before being submitted.

The structure of the writing module 310 may be configurable with criteria specific to a particular organization and/or company such configuration may be implemented via a separate file (e.g., a file with a .XML extension that may conform to the XML language). The setup (or configuration) of the writing module 310 may be done by a system administrator and/or other person working for the company. The person configuring the writing module 310 is generally familiar with the procedures and/or criteria of a particular company. The tool 300 may allow a template system to be implemented that may be changed to accommodate subsequent changes in the submission process. The XML file may include different types of inputs needed and/or links to help files and/or other documentation.

The software tool 300 may implement a search feature by presenting a request (e.g., USER_ACTION_2) to the block 312. The block 312 may allow the inventor to search through previous submissions that have been made through the tool 300. The search module 312 may allow the inventor to receive a list of what has been previously submitted. The search block 312 may check to see if an idea has already been submitted as a disclosure. The submit block 314 may respond to a request (e.g., USER_ACTION_3).

The home page 308 may provide the inventor with the option to collaborate with other employees. The tool 300 may help with such collaboration by sending an idea that is currently in a pre-submission state (i.e., the editing state) to selected co-workers. Such collaboration may be useful to receive comments and/or to solicit more ideas for the submission of the formatted disclosure. The tool 300 may track who actually made comments, so that when the actual submission is made, a decision on who the proper inventors are may be made.

The home page 308 may also provide a link to allow each un-submitted patent idea to be automatically submitted for review. Such a submission feature may rely on a particular company supporting some sort of online method of submitting patent disclosures. The particular coding may need to be customized on a per company basis (or possibly configured via script and/or XML file).

The tool 300 may be useful for a single disclosure with two patentable ideas. For example, if one idea has already been submitted as a formatted disclosure, a second idea may be submitted as another formatted disclosure at a later time. If a second idea is considered a new invention, a determination of how different the second idea was compared with the first idea may be made. If the second idea was “different enough” to support a disclosure, a new patent idea may be started. If more information was added to an existing disclosure (e.g., if the existing idea had not been submitted to the Patent Office yet), then the tool 300 may allow the inventors to make changes which may be tracked. Such tracking may be implemented by versioning the disclosure record. Subsequent users may be able to easily tell what had changed in comparison to the original disclosure. Such an update feature may be useful if a disclosure had been reviewed and rejected, and the inventors added more information and re-submitted the disclosure.

The tool 300 may also be useful for a shared idea started by two different inventors (e.g., a collaboration case). The system may have a feature that would check a submitted idea against existing ideas, and check for similarities in the idea text. The tool 300 may help avoid relying on the manual review process. Another disclosure submitted by another inventor may also be found.

The tool 300 may also be useful for a disclosure presented to a legal department where the inventor later finds a mistake and needs to make changes. The tool 300 may allow changes to a disclosure after the disclosure has been submitted. In one example, a window may be provided where the disclosure may not be changed (e.g., while under review). Either before or after the review, changes may be made. If changes are made, the tool 300 may initiate a re-review of the disclosure. In one example, the changes may be reviewed at a later time after the disclosure was rejected.

The tool 300 may also be useful for a single idea that becomes multiple disclosures. The tool 300 may support a simple database “one-to-many” relationship. Such a feature may be useful where one general idea becomes a base disclosure, and a number of follow-on disclosures are also presented.

The tool 300 may also be useful for a disclosure ready to be handed over to a legal department. The inventor(s) may have the option to place the disclosure in a state (e.g., ready for review) that would indicate to the legal department that the disclosure was ready.

The disclosure 300 may also be useful for merging multiple disclosures into a single patent application. Such merging may be done by an internal legal department or by outside counsel. Outside counsel may have access to the tool 300 with a subset of capabilities. In one example, operations by outside counsel may be treated as requests that may need confirmation by a company employee. For example, the administrator for the tool 300 may have the capability to allow an external inventor permission to see certain disclosures and/or ideas. If the internal legal department determined that other disclosures applied to a given disclosure, then permission may be granted to the outside counsel to be able to view all of the related disclosures.

The tool 300 may be used to file (or help generate documents for filing) the application with one or more Patent Offices. The tool 300 may also be used to automatically generate (based on one or more templates) documentation for a submission to one or more Patent Offices. The entire process may be implemented in “modules”, such as (i) Writer (e.g., done by the inventor), (ii) Reviewer (e.g., done by internal legal dept), and (iii) Submit (e.g., done by internal legal dept).

In one example, a Reviewer module may be implemented. For example, one or more reviewers may log into the tool 300, there may be a queue of formatted disclosures that have been submitted by inventors for review. The reviewers may look at a particular disclosure, grade the disclosure according to internal corporate review standards, and/or attach comments to the disclosure. The information (e.g., grades and/or comments) may be available to associated inventors the next time that they log into the tool 300.

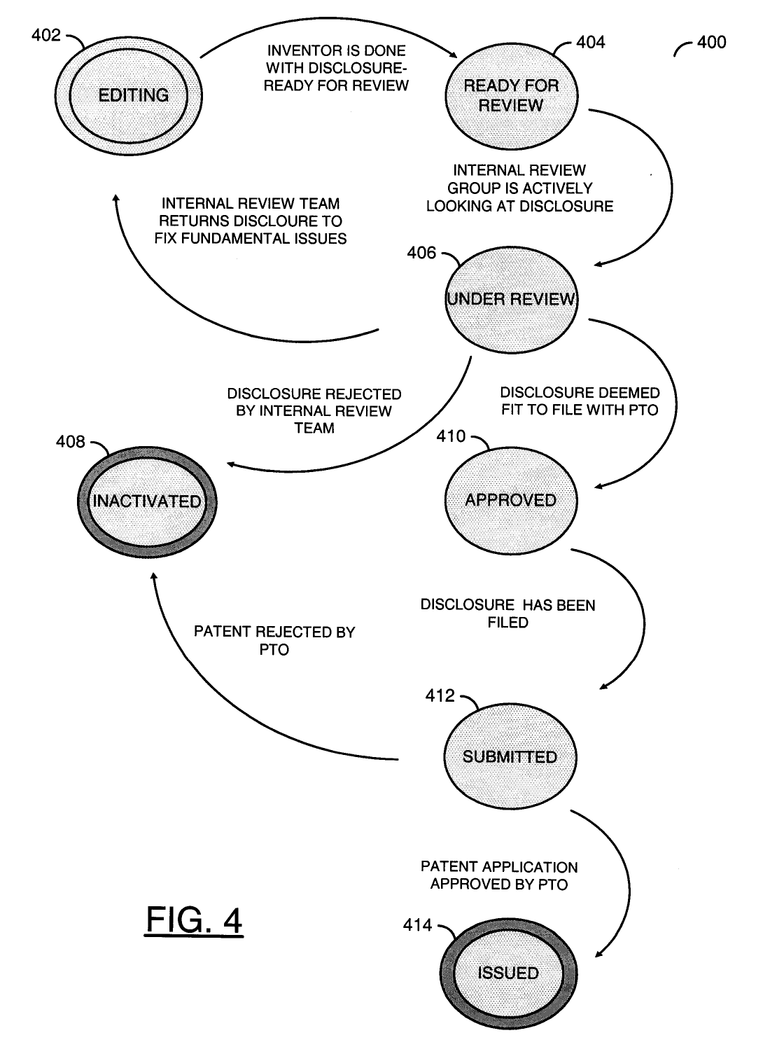

Referring to FIG. 4, a state diagram of a method (or process) 400 is shown in accordance with another embodiment of the present invention. The method 400 generally comprises a state (or step) 402, a state (or step) 404, a state (or step) 406, a state (or step) 408, a state (or step) 410, a state (or step) 412, and a state (or step) 414. The method 400 may be implemented as a Submit module.

In the state 402, the inventor may edit the disclosure. When the inventor is done with the disclosure, the disclosure may be ready for review. The method 400 may move to the state 404 when the disclosure is ready for review. In the state 406, an internal review group may actively look at the disclosure. If the disclosure is approved, then the method 400 may move to the state 410. If the disclosure is rejected by the internal review team, then the method 400 may move to the state 408. In the state 408, the disclosure may be inactivated. In the state 410, the disclosure may be deemed to be fit to file with the United States Patent and Trademark Office (USPTO). In the state 412, the disclosure (i.e., a patent disclosure) may be filed with the USPTO. If the patent disclosure is rejected by the USPTO then the method 400 may move to the state 408. If the patent disclosure is approved by the USPTO, then the method 400 moves to the state 414. In the state 414, the patent disclosure may be issued.

The Submit module 400 may be implemented after the “Reviewer” module activity has been completed. A disclosure may have a status state such as Editing, Ready for Review, Under Review, Inactivated, Approved, etc. When the reviewers of a particular disclosure have completed review, the status may be updated appropriately. If the disclosure is deemed worthy of being submitted to one or more Patent Offices, then the state would be set accordingly. Once a patent disclosure has been created for the disclosure, the Submit module 400 may create some of the necessary paperwork (or file electronically, if applicable).

The tool 300 may provide a streamlined process for developing disclosures. The tool 300 may reduce the number of manual steps involved in creating a disclosure. Collaboration of details and/or ideas with co-inventors may be enhanced. Merging information from multiple inventors may be done automatically by the tool 300. The tool 300 may provide a system to check on the status of a disclosure. The tool 300 may provide an interactive interface. When a disclosure is being reviewed, the tool 300 may provide visible evidence of what is currently going on. The tool 300 may consolidate all of the disclosure information, and once the disclosure is defined, change the state of the disclosure to “Ready for Review”. The tool 300 may be setup to automatically notify the legal department when a disclosure may be ready for review. In such an example, the review of the disclosure may be scheduled with one or more reviewers.

In one example, the tool 300 may be implemented as a web-based client running from a central server. Various users (e.g., the outside counsel, inventors, paralegals, etc.) would not have to install local software. For example, the tool 300 may run as an application on a web-site that is both inward-facing (for the corporate intranet), and outward-facing (to the Internet). The corporation would have to grant access/create accounts for outside counsel as it is needed. Once logged in, outside counsel would at least be granted permission to upload files.

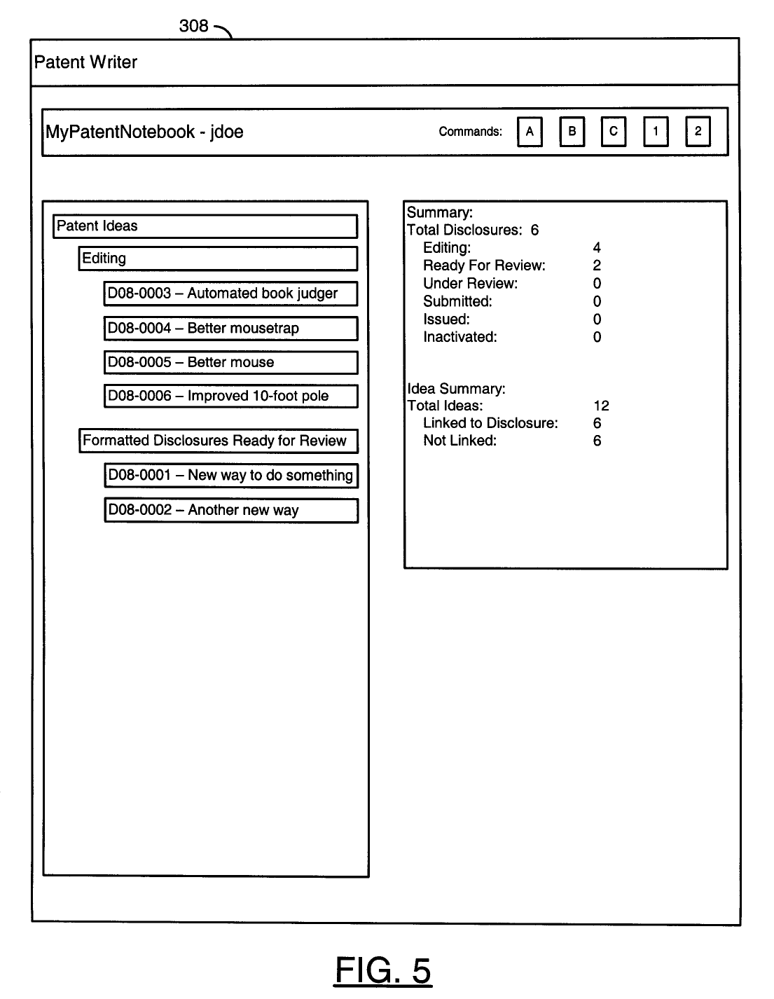

Referring to FIG. 5, a block diagram of an example of a main application interface page 308 is shown. In an example of an operation, an inventor may open the tool 300 (e.g., on a personal computer or other browser enabled device). After entering a username and a password on the login page 302, the main application interface page 308 may be displayed. In one example, a preference may have been configured so that the first screen is a summary screen (e.g., similar to the Outlook Today screen from Microsoft Outlook). The left side of the screen may present a tree-view control, which may be switched between looking at “Patent Disclosures” or “Patent Ideas”. By default, the inventor may set the first screen to show the “Patent Ideas” tree, which may have folders for currently editing and previously submitted patent ideas. The right side of the screen may show that the inventor currently has (i) four disclosures that are in an editing state and have not been submitted, (ii) two disclosures that have been submitted, and (iii) a handful (e.g., six) of pre-disclosure “ideas” that the inventor has yet to convert into full-fledged disclosures. The tree shown may be an example. More or less of each state of the disclosures may be present. The inventor may decide to work on finishing a disclosure, so the inventor may click on the toolbar button for “Patent Disclosures”. The inventor may also do an update through the main menu at the top of the tool 300.

The tool 300 may now show a disclosure summary screen. In one example, a list of active disclosures may be displayed. Two submitted disclosures may be shown, along with corresponding internal docket numbers, and the current state in the internal corporate system. Of the four disclosures shown in FIG. 5 that are still being edited, the inventor may see how much work has been done on each disclosure. An icon may indicate how many parts of the disclosure(s) currently have at least something added. On one of the disclosures, the inventor may notice that no drawings have been submitted. The inventor may click on the link for this disclosure.

The tool 300 may now present a tree-view on the left-hand side of the screen (not shown). The root of the tree may be an identifier for the particular disclosure. As the inventor clicks on the tree, various folders appear for the different parts of the disclosure. The inventor may right-click on the “Attachments” folder, and may choose to “Add” a new item. A dialog may present the ability to browse a local hard drive for one or more files to attach. The inventor may notice that a Microsoft Visio flowchart has already been created for this disclosure. The inventor may then locate the file and select the file to be attached. In one example, the inventor may not have faith in his ability to generate a schematic drawing in a computer application, so the inventor may also have one or more pen-and-paper drawings that may have been previously scanned and/or otherwise converted to graphics files.

The inventor may then select those files and attach the files to the disclosure. The inventor may then be satisfied with the attachments. The inventor may now take a quick look at the rest of the tree view for the disclosure. The inventor may decide to add additional information to the “Details” section of the disclosure. The inventor may click on that folder in the tree, and then select the “Details” child element underneath. The rest of the screen may convert to a rich-text editor, containing the previous contents of the “Details” section. The inventor may add another paragraph or two, and save the changes.

The inventor may be pretty sure that all the needed work is done with the disclosure and may decide to run a check on the disclosure. The inventor may go to the main menu, and select the “Disclosures>>Check” option. The tool 300 may run a general check to make sure all of the sections have been filled in, and also do a cursory spelling and grammar check. The tool 300 may deem the disclosure ready to submit, so the inventor may select the “Disclosures>>Submit” option from the main menu. The tool 300, based on a configuration file designed for the particular internal patent procedures of a particular corporation, may create a document containing all of the disclosure information contained in the system. The document may then be automatically sent to the corporate patent office to be processed as needed.

The inventor may now go back to the main disclosures screen. The status of the disclosure worked on may be updated to show that the last disclosure discussed has been submitted. The inventor may be done working on disclosures for now, but may be curious about an existing disclosure submitted through the system, perhaps currently at the U.S. Patent and Trademark Office (USPTO). The inventor may go back to the main application screen, and may then go to the left-hand tree view, which may be currently showing the list of disclosures that have been submitted. The inventor may click on the folder for “Previously Submitted” disclosures, and go through the list until an older disclosure is located. Clicking on the older disclosure may cause the main application window 308 to show a summary of the disclosure, including the status of the patent disclosure at the USPTO.

The inventor may now be done working with all of the disclosures for the day. Before logging out, the inventor may decide to add a couple of new “Ideas” to the list. The inventor may click on a toolbar button for “Ideas”, and may receive a summary view. The inventor may now see that several ideas have already turned into disclosures. If desired, the inventor may click on an item and take a look at the linked disclosure. The inventor may add a couple of more ideas to the list. Once finished, the inventor may decide to share one of the ideas with a co-worker. The inventor may select a particular item from the list, and may select “Share . . . ”. A wizard may walk the inventor through picking a particular user intended to be able to see the idea. In one example, the inventor may make the disclosure completely public, where everyone may see the disclosure. In another example, the inventor may decide to share the disclosure with just one co-worker. The inventor may choose the name of the desired co-worker from a list of users, and then close the wizard. When the co-worker logs into the tool 300, the co-worker will see the idea originally created by the inventor in a list. An icon may indicate that the disclosure is shared, and may display a tooltip that indicates who created the disclosure. If either the inventor or the co-worker decides to create a disclosure based on the idea, then the resulting idea will have the same visibility as the original idea, and will show up on both the list of the inventor and the co-worker.

The function performed by the flow diagrams of FIGS. 1 and 2 may be implemented using a conventional general purpose digital computer programmed according to the teachings of the present specification, as will be apparent to those skilled in the relevant art(s). Appropriate software coding can readily be prepared by skilled programmers based on the teachings of the present disclosure, as will also be apparent to those skilled in the relevant art(s).

The present invention may also be implemented by the preparation of ASICs, FPGAs, or by interconnecting an appropriate network of conventional component circuits, as is described herein, modifications of which will be readily apparent to those skilled in the art(s).

The present invention thus may also include a computer product which may be a storage medium including instructions which can be used to program a computer to perform a process in accordance with the present invention. The storage medium can include, but is not limited to, any type of disk including floppy disk, optical disk, CD-ROM, magneto-optical disks, ROMs, RAMs, EPROMs, EEPROMs, Flash memory, magnetic or optical cards, or any type of media suitable for storing electronic instructions.

While the invention has been particularly shown and described with reference to the preferred embodiments thereof, it will be understood by those skilled in the art that various changes in form and details may be made without departing from the scope of the invention.

1. A computer readable medium configured to store instructions for executing the following steps:
(A) accepting a first number of user parameters to be organized as a patent idea;
(B) accepting a second number of user parameters to add to said patent idea;
(C) storing (i) said first number of user parameters, (ii) said second number of user parameters, and (iii) the identity of a user associated with (a) said first number of user parameters and (b) said second number of user parameters;
(D) insuring that information specific to a plurality of criteria of a particular organization is complete; and
(E) converting said patent idea into a patent disclosure data by merging said first number of user parameters and said second number of user parameters with a configurable patent disclosure template in response to a user initiated instruction, wherein said patent disclosure data complies with said plurality of criteria.

2. The computer readable medium according to claim 1, wherein said first number of user parameters and said second number of user parameters are received from a first inventor.

3. The computer readable medium according to claim 2, wherein a third set of user parameters are received from a second inventor and step (C) further comprises storing said third set of user parameters and the identity of said second inventor.

4. The computer readable medium according to claim 3, wherein said first inventor and said second inventor collaborate on said patent idea before step (E) converts said patent idea into said patent disclosure data.

5. The computer readable medium according to claim 1, wherein said first number of user parameters are accepted through a web based interface.

6. The computer readable medium according to claim 1, further comprising:
storing said patent idea prior to step (E).

7. The computer readable medium according to claim 1, further comprising:
accepting a third number of user parameters to organize as a subsequent patent idea.

8. The computer readable medium according to claim 7, further comprising:
storing said subsequent patent idea.

9. The computer readable medium according to claim 1, further comprising:
searching said patent idea, and said subsequent patent idea for information relevant to a second subsequent patent idea.

10. The computer readable medium according to claim 1, further comprising:
attaching one or more computer files to said idea.

11. The computer readable medium according to claim 5, wherein a plurality of inventors access said web based server.

12. The computer readable medium according to claim 1, further comprising:
submitting said patent disclosure data to the United States Patent and Trademark Office.

13. An apparatus comprising:
means for accepting a first number of user parameters to be organized as a patent idea;
means for accepting a second number of user parameters to add to said patent idea;
means for storing (i) said first number of user parameters, (ii) said second number of user parameters, and (iii) the identity of a user associated with (a) said first number of user parameters and (b) said second number of user parameters;
means for insuring that information specific to a plurality of criteria of a particular organization is complete; and
means for converting said patent idea into a patent disclosure data by merging said first number of user parameters and said second number of user parameters with a configurable patent disclosure template in response to a user initiated instruction, wherein said patent disclosure data complies with said plurality of criteria.

14. A method for developing a patent disclosure data comprising the steps of:
(A) accepting a first number of user parameters to be organized as a patent idea;
(B) accepting a second number of user parameters to add to said patent idea;
(C) storing (i) said first number of user parameters, (ii) said second number of user parameters, and (iii) the identity of a user associated with (a) said first number of user parameters and (b) said second number of user parameters;
(D) insuring that information specific to a plurality of criteria of a particular organization is complete; and
(E) converting said patent idea into said patent disclosure data by merging said first number of user parameters and said second number of user parameters with a configurable patent disclosure template in response to a user initiated instruction, wherein said patent disclosure data complies with said plurality of criteria.

15. The computer readable medium according to claim 3, wherein said first number of user parameters, said second number of user parameters, and said third number of user parameters are used to determine the identity and contribution of said first inventor and said second inventor for said patent disclosure data.
